(19) United States
(12) Patent Application Publication
(10) Pub. No.: US 2010/0309515 A1
(43) Pub. Date: Dec. 9, 2010

(54) DISPLAY CONTROL APPARATUS, DISPLAY CONTROL METHOD, AND COMPUTER-READABLE STORAGE MEDIUM

(75) Inventor: Masayuki Odagawa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/792,661

(22) Filed: Jun. 2, 2010

(30) Foreign Application Priority Data
Jun. 3, 2009 (JP) 2009-134270
Jun. 10, 2009 (JP) 2009-139599

(51) Int. Cl. G06F 3/12

(52) U.S. Cl. 358/1.15

(57) ABSTRACT

A display control apparatus includes a detection unit configured to detect a position of a printing apparatus, which is close to or in contact with a display screen, a setting unit configured to set a display area corresponding to a position detected by the detection unit, a generation unit configured to generate a preview image of content data displayed on the display screen, and a display control unit configured to cause the preview image generated by the generation unit to be displayed on the display area set by the setting unit.

### BACKGROUND OF THE INVENTION

1. Field of the Invention

The present invention relates to a technique for generating and displaying a preview image of content data to be displayed on a display screen.

2. Description of the Related Art

Conventionally, when a preview image is displayed for a user to previously confirm a print image of a content displayed on a display device, the user connects the display device to a printer and selects a content as a print target. The preview image is then displayed from a menu supplied on a dialog window.

Japanese Patent Application Laid-Open No. 2004-229015 discusses a technique for displaying along with the preview image a type of the preview image in the vicinity of the preview image.

Further, when the preview image is for the user to previously confirm the print image of the content displayed on the display device, the user selects the content for each printer, and the preview image is then generated and displayed.

However, according to the conventional technique, operations for displaying a preview print image of the content on the display device is complicated. It is thus burdensome for the user to display the preview print image for a plurality of contents.

Further, the technique discussed in Japanese Patent Application Laid-Open No. 2004-229015 does not consider displaying the preview print image of the content on the display device.

Furthermore, according to the conventional technique, operations for displaying a preview print image of the content on the display device is complicated. It is thus burdensome for the user to display the preview print image of the content for a plurality of printers.

### SUMMARY OF THE INVENTION

The present invention is directed to a display control apparatus and a display control method capable of easily displaying a preview image of content data to be displayed on a display screen without complicated operations. Further, the present invention is directed to a display control apparatus and display control method capable of easily displaying a preview list of print images corresponding to each of a plurality of printers.

According to an aspect of the present invention, a display control apparatus includes a detection unit configured to detect a position of a printing apparatus which is close to or in contact with a display screen, a setting unit configured to set a display area corresponding to a position detected by the detection unit, a generation unit configured to generate a preview image of content data displayed on the display screen, and a display control unit configured to cause the preview image generated by the generation unit to be displayed on the display area set by the setting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image display apparatus according to a first exemplary embodiment of the present invention.

FIG. 2 is a flowchart illustrating an operation performed by an image display apparatus according to the first exemplary embodiment of the present invention.

FIG. 3 is a schematic diagram illustrating an operation performed by an image display apparatus according to the first exemplary embodiment of the present invention.

FIG. 4 illustrates an example of characteristic information of a printer according to the first exemplary embodiment of the present invention.

FIG. 5 is a block diagram illustrating a configuration of an image display apparatus according to a second exemplary embodiment of the present invention.

FIG. 6 is a flowchart illustrating an operation performed by an image display apparatus according to the second exemplary embodiment of the present invention.

FIG. 7 illustrates an example of a preview image.

FIG. 8 illustrates an example of printer characteristic information.

FIG. 9 illustrates an example of characteristic information of a printer according to the second exemplary embodiment of the present invention.

### DESCRIPTION OF THE EMBODIMENTS

Various exemplary embodiments, features, and aspects of the invention will be described in detail below with reference to the drawings.

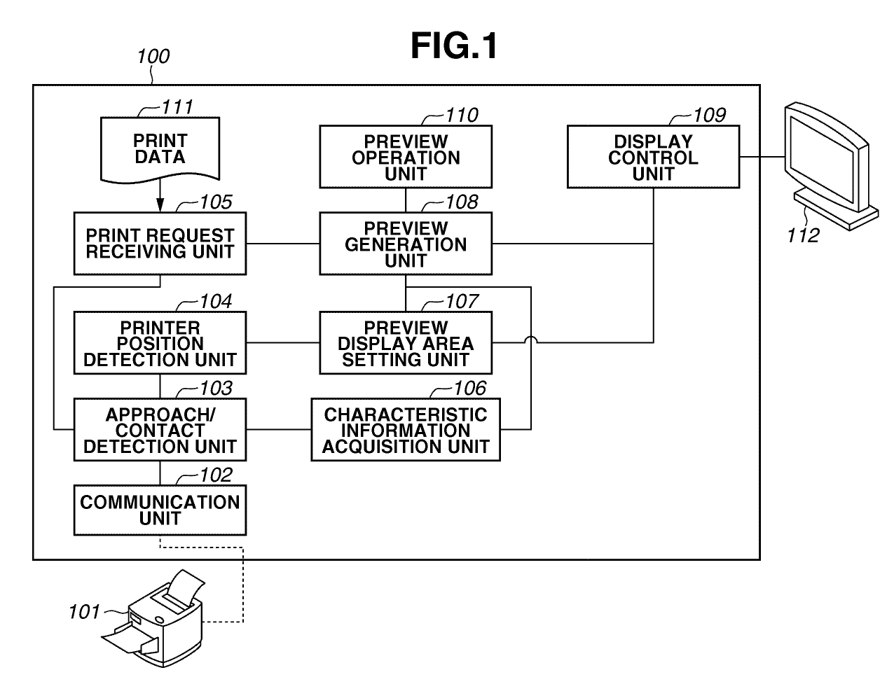

FIG. 1 is a block diagram illustrating a configuration of an image display apparatus 100 according to a first exemplary embodiment of the present invention. Referring to FIG. 1, the user places a printer 101 close to or to be in contact with a display apparatus 112. It is preferable for the printer 101 to be a portable and compact printer. The image display apparatus 100 is an application example of a display control apparatus according to the present invention, and the printer 101 is an application example of a printing apparatus according to the present invention.

A communication unit 102 communicates with and connects to the printer 101. A known wireless communication technology is employed for connecting with the printer 101.

An approach/contact detection unit 103 detects the printer 101 approaching or coming into contact with the display apparatus 112. When a print request receiving unit 105 receives a print request from the user, the approach/contact detection unit 103 detects the printer 101 close to or in contact with the display apparatus 112. The approach/contact detection unit 103 then notifies a characteristic information acquisition unit 106 and a printer position detection unit 104 thereof.

The printer position detection unit 104 detects a position at which the printer 101 detected by the approach/contact detection unit 103 is close to or is in contact with the display apparatus 112. The printer position detection unit 104 is an application example of a detection unit according to the present invention.

The print request receiving unit 105 receives from the user a print request of print data 111. Upon receiving the print request, the print request receiving unit 105 notifies and causes the approach/contact detection unit 103 to detect the printer 101 which is close to or is in contact with the display apparatus 112.

A characteristic information acquisition unit 106 acquires when receiving the notification from the approach/contact detection unit 103 the characteristic information of the detected printer 101 from the printer 101 via the communication unit 102. The acquired information is then used by a preview generation unit 108. The characteristic information acquisition unit 106 is an application example of an acquisition unit according to the present invention.

A preview display area setting unit 107 sets a preview display area adjacent to a position detected by the printer position detection unit 104. The preview display area setting unit 107 is an application example of a setting unit according to the present invention.

The preview generation unit 108 generates the preview image of the print data 111 according to the characteristic information of the printer 101 acquired by the characteristic information acquisition unit 106. The preview generation unit 108 is an application example of a generation unit according to the present invention.

A display control unit 109 displays the content data (hereinafter referred to as content) and the preview image on the display apparatus 112. The display control unit 109 is an application example of a display control unit according to the present invention.

A preview operation unit 110 instructs operations such as enlarging and reducing the preview image or scrolling the preview image.

The print data 111 is displayed as the content image on a screen of the display apparatus 112.

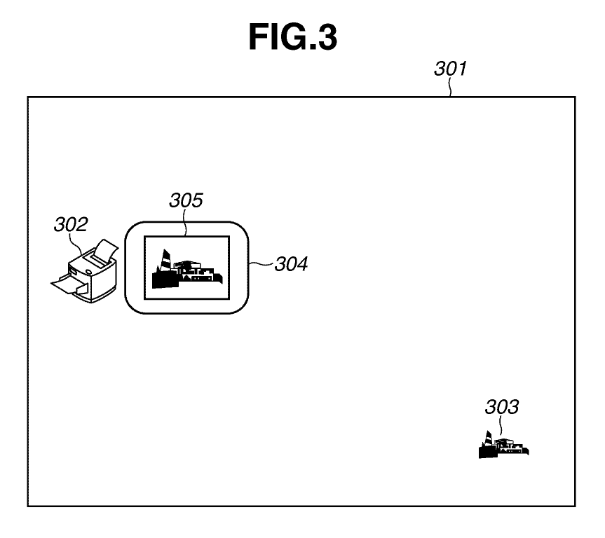

An outline of the operation performed by the image display apparatus 100 according to the present exemplary embodiment will be described below with reference to FIG. 3. Referring to FIG. 3, a display screen 301 is displayed on the display apparatus 112 illustrated in FIG. 1, and a printer 302 corresponds to the printer 101. Content 303 is displayed on the display screen 301, and a preview display area 304 displays a preview image 305. The printer 302 is placed in contact with the display screen 301.

When the user issues the print request to print the content 303 as the print data, the preview display area 304 is set in an area adjacent to the printer 302. The preview generation unit 108 generates the preview image 305 based on the characteristic information of the printer 302. If settings indicated in the characteristic information of the printer 302 specify bordered landscape printing, the preview image 305 becomes as illustrated in FIG. 3.

The preview display area 304 may be kept on the display screen 301 even after the printer 302 has been removed from the display screen 301. In other words, the preview display area 304 may be kept on the display screen 301 even after the printer 302 becomes undetectable by the approach/contact detection unit 103.

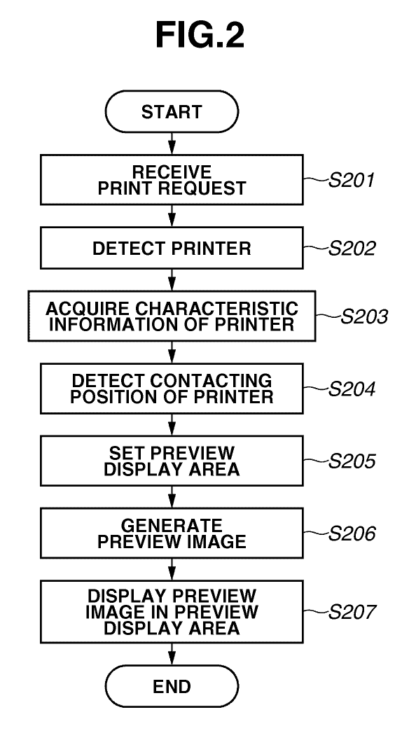

The operation performed by the image display apparatus 100 according to the present exemplary embodiment will be described in detail below with reference to the flowchart illustrated in FIG. 2.

In step S201, upon the user selecting the content 303 and issuing the print request, the print request receiving unit 105 receives the print request and notifies the approach/contact detection unit 103 thereof.

In step S202, the approach/contact detection unit 103 then detects the printer 302 close to or in contact with the screen of the display apparatus 112. In step S203, the approach/contact detection unit 103 notifies the characteristic information acquisition unit 106 of detecting the printer 302.

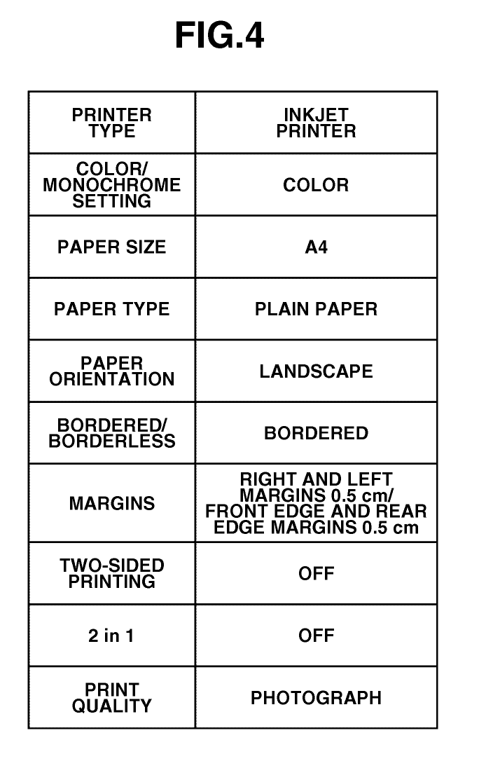

Upon receiving the notification from the approach/contact detection unit 103, in step S203, the characteristic information acquisition unit 106 acquires the characteristic information of the printer 302 detected by the approach/contact detection unit 103. For example, the characteristic information acquisition unit 106 acquires from the printer 101 the characteristic information illustrated in FIG. 4.

In step S204, the printer position detection unit 104 receives the notification from the approach/contact detection unit 103 and then detects a contact position of the printer 302 detected by the approach/contact detection unit 103. The printer position detection unit 104 then notifies the preview display area setting unit 107 of detecting the contact position of the printer 302.

In step S205, the preview display area setting unit 107 receives the notification from the printer position detection unit 104. The preview display area setting unit 107 then sets the preview display area 304 in an area adjacent to the contact position of the printer 302 detected by the printer position detection unit 104. The size of the preview display area 304 is fixed at 360 pixels×240 pixels at initial setting. However, the user may change the size of the area. After setting the preview display area 304, the preview display area setting unit 107 notifies the preview generation unit 108.

In step S206, the preview generation unit 108 receives the notification from the preview display area setting unit 107, and then generates the preview image 305. The preview generation unit 108 generates the preview image 305 based on the characteristic information of the printer 302 acquired by the characteristic information acquisition unit 106.

FIG. 4 illustrates the characteristic information of the printer 302 to be used by the preview generation unit 108. The preview generation unit 108 generates the preview image 305 according to the setting values and the characteristic values indicated in the characteristic information illustrated in FIG. 4. In step S207, the display control unit 109 then performs control to display the generated preview screen 305 in the preview display area 304.

In the example of the characteristic information illustrated in FIG. 4, “inkjet printer” is set to a characteristic value of a printer type. Further, “color” is set as the characteristic value to color/monochrome setting, “A4” to paper size, “regular paper” to paper type, and “landscape” to paper orientation. Furthermore, “bordered printing” is set to bordered/borderless printing, “right and left margins 0.5 cm/front edge and rear edge margins 0.5 cm” to margin size, “off” to double-sided printing, “off” to 2in1 printing, and “photograph” to print quality.

The preview generation unit 108 generates the preview image 305 corresponding to the above-described setting values and characteristic values. In the example illustrated in FIG. 4, both the setting values and the characteristic values are included in the characteristic information. However, the characteristic information may also include only one of the values.

According to the present exemplary embodiment, the preview display area 304, which corresponds to the position of the printer 302, is set by causing the printer 302 to come close to or be in contact with the display screen 301. The preview image 305 of the content 303 displayed on the display screen 301 is then generated and displayed on the preview display area 304. As a result, the user can easily preview the preview image 305 of the content 303 displayed on the display screen 301 without having to perform complicated operations.

The present exemplary embodiment describes the operation of displaying the preview image by the printer 302 coming close to or in contact with the display screen 301. However, similar results and effects may be acquired when a detachable portion of a printer comes close to or in contact with the display screen 301.

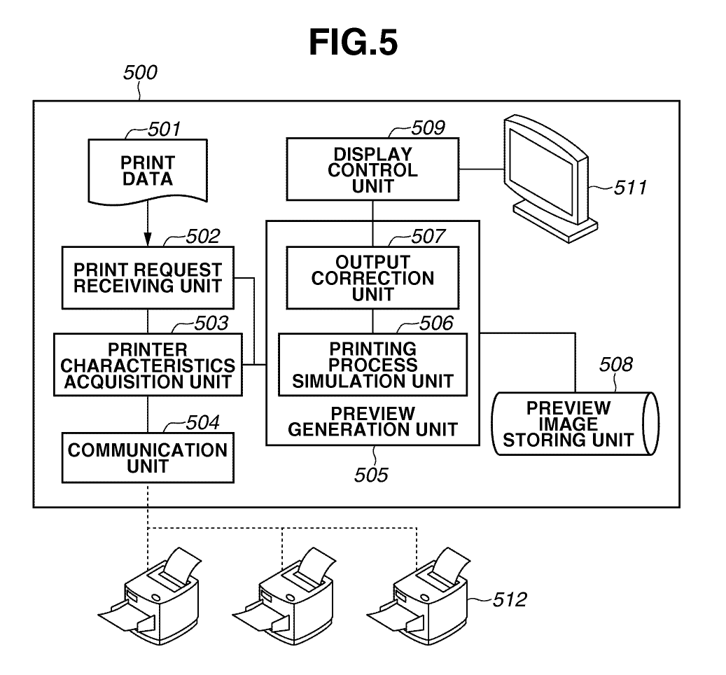

FIG. 5 is a block diagram illustrating a configuration of an image display apparatus according to a second exemplary embodiment of the present invention. Referring to FIG. 5, an image display apparatus 500 according to the present exemplary embodiment includes a print request receiving unit 502, which receives the print request from the user with respect to print data 501. Upon receiving the print request, the print request receiving unit 502 notifies a printer characteristic acquisition unit 503 thereof. The image display apparatus 500 is an application example of an information processing apparatus according to the present invention.

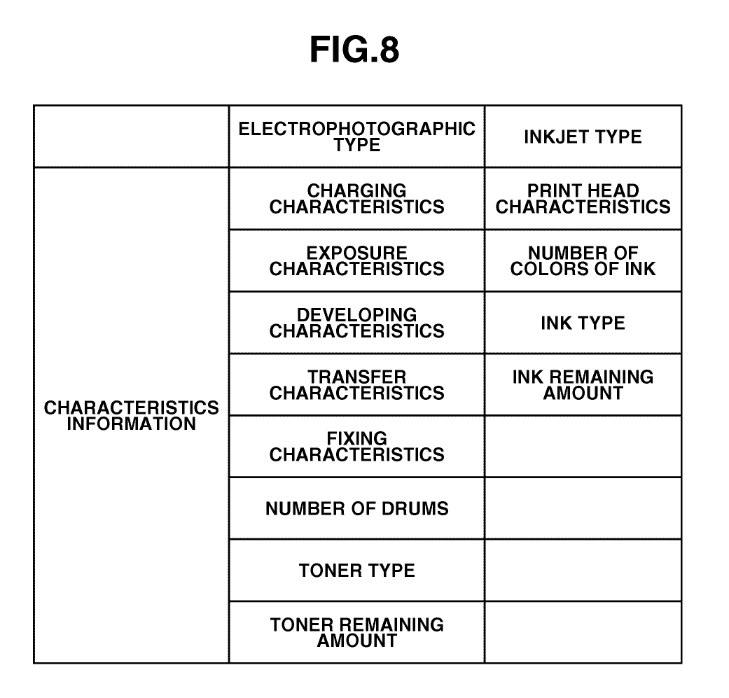

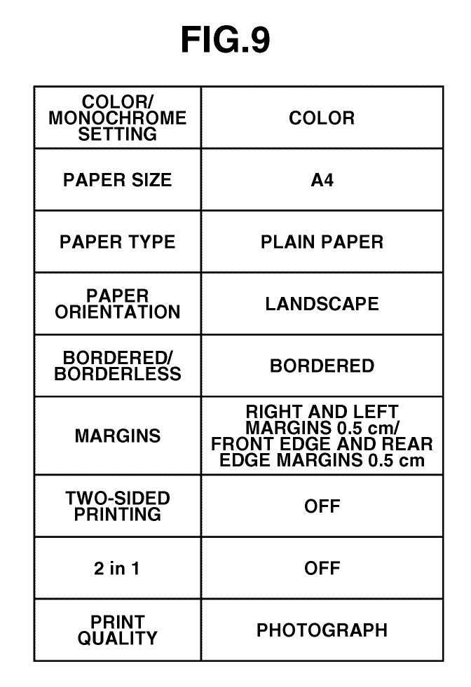

Upon receiving the notification from the print request receiving unit 502, the printer characteristic acquisition unit 503 acquires characteristic information and setting information of a printer 512 connected to the image display apparatus 500 via a communication unit 504. FIG. 8 illustrates an example of the characteristic information of the printer 512 acquired by the printer characteristic acquisition unit 503. FIG. 9 illustrates an example of the setting information of the printer 512 when performing printing. The printer characteristic acquisition unit 503 is an application example of a first acquisition unit and a second acquisition unit according to the present invention.

Referring to FIG. 8, if the printer 512 is an electrophotographic printer, the characteristic information includes charging characteristics, exposure characteristics, developing characteristics, transfer characteristics, and fixing characteristics of toner, number of drums, type of toner, and toner remaining amount. Further, if the printer 512 is an inkjet printer, the characteristic information includes print head characteristics, number of colors of ink, type of ink, and ink remaining amount.

Referring to FIG. 9, the setting information of the printer 512 includes color/monochrome setting, paper size, paper type, paper orientation, bordered/borderless print setting, margin size, two-sided printing, 2in1 printing, and print quality.

Further, referring to FIG. 9, “color” is set to color/monochrome setting, “A4” to paper size, “plain paper” to paper type, “landscape” to paper orientation, “bordered” to bordered/borderless print setting, and “right and left margins 0.5 cm/front edge and rear edge margins 0.5 cm” to margin size. Furthermore, “off” is set to both two-sided printing and 2in1 printing, and “photograph” is set to print quality.

Referring to FIG. 5, the image display apparatus 500 further includes the communication unit 504 and a preview generation unit 505 configured of a printing process simulation unit 506 and an output correction unit 507. The preview generation unit 505 is an application example of a generation unit according to the present invention.

The printing process simulation unit 506 simulates the printing process for each of the printer 512 and generates the preview image data (hereinafter referred to as a preview image) of the print data 501 received by the print request receiving unit 502. The printing process simulation unit 506 generates the preview image according to the characteristic information and the setting information of each of the printers 512 acquired by the printer characteristic acquisition unit 503. The printing process simulation unit 506 is an application example of a simulation unit according to the present invention.

The printing process simulated by the printing process simulation unit 506 is different according to the type of the printer 512. If the printer 512 is the inkjet printer, the printing process simulation unit 506 simulates how ink droplets are ejected based on the print head characteristics, the number of colors of ink, the types of ink, and the ink remaining amounts illustrated in FIG. 8. Further, the printing process simulation unit 506 generates the preview image corresponding to the setting information illustrated in FIG. 9.

On the other hand, if the printer 512 is the electrophotographic printer, the printing process simulation unit 506 simulates each step based on the charging characteristics, the exposure characteristics, the developing characteristics, the transfer characteristics, and the fixing characteristics of toner, the number of drums, the type of toner, and the toner remaining amount. Further, the printing process simulation unit 506 generates the preview image corresponding to the setting information illustrated in FIG. 9. The printing process simulation unit 506 then transmits the generated preview image to the output correction unit 507.

The output correction unit 507 performs color correction on each of the preview images generated by the printing process simulation unit 506 to reproduce the colors of each of the printers 512 on a display apparatus 511. The output correction unit 507 thus performs color matching.

More specifically, the output correction unit 507 corrects the difference between outputs of the display apparatus 511 and each of the printers 512 (i.e., a difference in color and texture of outputs). A preview image storing unit 508 stores the corrected preview images. The output correction unit 507 is an application example of a correction unit according to the present invention.

A preview image storing unit 508 also stores the preview images generated by the preview generation unit 505.

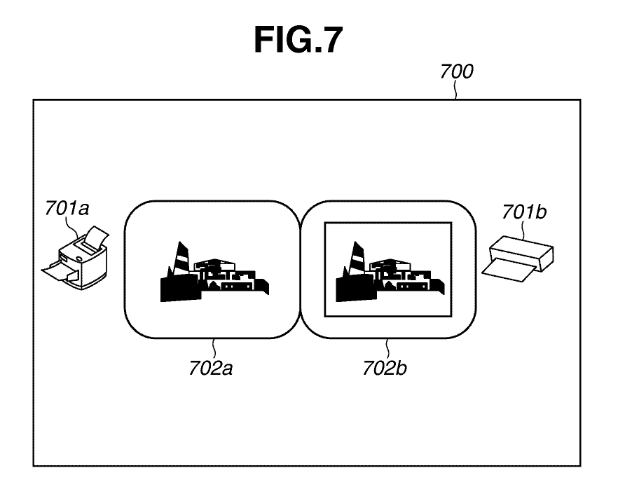

A display control unit 509 performs control to cause the display apparatus 511 to display the preview images. For example, the display apparatus 511 displays a preview image illustrated in FIG. 7. The printers 512 are connected to the image display apparatus 500. The display control unit 509 is an application example of a display control unit according to the present invention.

FIG. 7 illustrates an example of the preview image. Referring to FIG. 7, a preview image 700 is displayed on the display apparatus 511. Printers 701a and 701b indicate types of printers 512 connected to the image display apparatus 500. Further, preview images 702a and 702b correspond to the printer types indicated by the printers 701a and 701b adjacent thereto.

The preview image 702a corresponds to the setting information in which “borderless” is specified to the bordered/borderless printing in FIG. 9. On the other hand, the preview image 702b corresponds to the setting information in which “bordered” is specified to the bordered/borderless printing in FIG. 9.

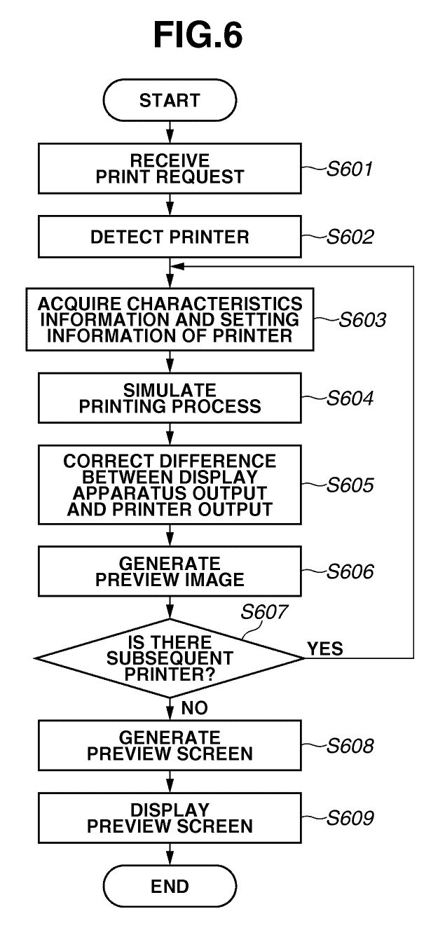

An operation performed by the image display apparatus 500 according to the present exemplary embodiment will be described below with reference to a flowchart illustrated in FIG. 6.

In step S601, upon the user selecting the print data 501 and issuing the print request, the print request receiving unit 502 receives the print request and notifies the printer characteristic acquisition unit 503 thereof.

In step S602, the printer characteristic acquisition unit 503 then detects the printer 512 connected to the image display apparatus 500.

In step S603, the printer characteristic acquisition unit 503 acquires the characteristic information and the setting information of the detected printer 512. For example, the printer characteristic acquisition unit 503 acquires the characteristic information illustrated in FIG. 8 and the setting information illustrated in FIG. 9 from the detected printer 512.

In step S604, the preview generation unit 505 receives the notification from the printer characteristic acquisition unit 503, and generates the preview image with respect to the print data 501. The preview generation unit 505 generates the preview image based on the characteristic information and the setting information of the detected printer 512 acquired by the printer characteristic acquisition unit 503. In other words, the printing process simulation unit 506 in the preview generation unit 505 simulates the printing process of the printer 512.

In step S605, the output correction unit 507 in the preview generation unit 505 corrects the difference between the outputs of the display apparatus 511 and the printer 512. In step S606, the preview generation unit 505 generates the preview image based on the printing process simulation result acquired in step S604 and the correction result acquired in step S605.

In step S607, the printer characteristic acquisition unit 503 determines whether the characteristic information and the setting information of all printers 512 detected in step S602 are acquired.

If there are printers 512 whose characteristic information and the setting information are not acquired (YES in step S607), the process returns to step S603, and the characteristic information and setting information acquisition process is performed. On the other hand, if the characteristic information and the setting information have been acquired from all of the printers 512 (NO in step S607), the process proceeds to step S608.

In step S608, after the preview images for all printers 512 have been generated, the display control unit 509 generates the preview screen including a list of the preview images of all printers 512.

In step S609, the display control unit displays the generated preview screen on the display apparatus 511.

As described above, according to the present exemplary embodiment, the preview images of the print data are generated corresponding to each of the printers 512 based on the characteristic information of the plurality of the printers 512. The list of the preview images is then displayed. As a result, the user can easily preview the list of the print images corresponding to each of the printers 512 without having to perform complicated operations.

Further, according to the present exemplary embodiment, the printing process of the print data 501 performed in each printer 512 is simulated. The preview image in which the difference between the outputs of the display apparatus 511 and the printer 512 is corrected is then generated. The preview image of an image quality acquired by further considering the final print result of each printer 512 can thus be displayed.

Each of the units and steps configuring the above-described exemplary embodiments of the present invention can also be achieved by executing a program stored in a random access memory (RAM) or a read-only memory (ROM) in a computer. The program and the computer-readable storage medium may thus constitute the present invention.

Further, the present invention can be embodied as a system, apparatus, method, program, or a storage medium. More specifically, the present invention can be applied to a system including a plurality of devices or to an apparatus of a single device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2009-134270 filed Jun. 3, 2009 and No. 2009-139599 filed Jun. 10, 2009, which are hereby incorporated by reference herein in their entirety.

What is claimed is:

1. A display control apparatus comprising:
a detection unit configured to detect a position of a printing apparatus, which is close to or in contact with a display screen;
a setting unit configured to set a display area corresponding to a position detected by the detection unit;
a generation unit configured to generate a preview image of content data displayed on the display screen; and
a display control unit configured to cause the preview image generated by the generation unit to be displayed on the display area set by the setting unit.

2. The display control apparatus according to claim 1, wherein the display area is set at a position close to a position detected by the detection unit.

3. The display control apparatus according to claim 1, further comprising an acquisition unit configured to acquire information including at least one of characteristic and settings of the printing apparatus,
wherein the generation unit generates the preview image based on information acquired by the acquisition unit.

4. The display control apparatus according to claim 1, wherein the display area is kept on the display screen even after the printing apparatus is removed from the display screen.

5. A display control apparatus comprising:
a first acquisition unit configured to acquire characteristic information of a plurality of printers;
a generation unit configured to generate preview image data of print data corresponding to each of the plurality of printers based on each of characteristic information acquired by the first acquisition unit; and
a display control unit configured to cause a display apparatus to display a list of preview image data generated by the generation unit.

6. The display control apparatus according to claim 5, further comprising a second acquisition unit configured to acquire setting information with regard to printing performed by the plurality of printers,
wherein the generation unit generates preview image data of print data corresponding to each of the plurality of printers based on each of setting information acquired by the second acquisition unit.

7. The display control apparatus according to claim 5, wherein the generation unit includes a simulation unit configured to simulate a process for printing print data in each of the plurality of printers based on each of characteristic information acquired by the first acquisition unit, and
wherein the generation unit generates preview image data corresponding to each of the plurality of printers based on a simulation result of the simulation unit.

8. The display control apparatus according to claim 7, wherein the generation unit includes a correction unit configured to correct a difference between outputs of each of the plurality of printers and the display apparatus, and
wherein the generation unit generates preview image data corresponding to each of the plurality of printers based on correction results of the correction unit.

9. A display control method performed by a display control apparatus, the method comprising:
detecting a position of a printing apparatus, which is close to or in contact with a display screen;
setting a display area corresponding to the detected position;
generating a preview image of content data displayed on the display screen; and
causing the generated preview image to be displayed on the set display area.

10. A display control method performed by a display control apparatus, the method comprising:
acquiring characteristic information of a plurality of printers;
generating preview image data of print data corresponding to each of the plurality of printers based on each of the acquired characteristic information; and
causing a display apparatus to display a list of the generated preview image data.

11. A computer-readable storage medium for storing a program for causing a computer to execute a display control method, the method comprising:
detecting a position of a printing apparatus, which is close to or in contact with a display screen;
setting a display area corresponding to the detected position;
generating a preview image of content data displayed on the display screen; and
causing the generated preview image to be displayed on the set display area.

12. A computer-readable storage medium for storing a program for causing a computer to execute a display control method, the method comprising:
acquiring characteristic information of a plurality of printers;
generating preview image data of print data corresponding to each of the plurality of printers based on each of the acquired characteristic information; and
causing a display apparatus to display a list of the generated preview image data.
